(19) United States
(12) Patent Application Publication
(10) Pub. No.: US 2004/0047959 A1
(43) Pub. Date: Mar. 11, 2004

(54) Method of making 3-D (dimensional) egg-shape cookies

(76) Inventor: Chu-Yuan Liao, Taipei (TW)

Correspondence Address: Chu-Yuan Liao, P.O. Box No.6-57, Chung-Ho, Taipei, 235, TW

(21) Appl. No.: 10/237,046

(22) Filed: Sep. 9, 2002

(51) Int. Cl. A23G 1/00

(52) U.S. Cl. 426/390

(57) ABSTRACT

A method for making egg-shape cookies, particularly to a mold in the shape of an egg that is cut into half vertically. Two pieces of cookies are made separately with the mold and then adhered with fluid thereby forming a whole egg and any kind of little toys can be placed in inner space of the egg-shape cookies. Different from conventional method, the invention utilizes one single mold to make egg-shape cookies by which can reduce cost by consuming of the molds; in addition, toys insides may attract purchasing from consumers by satisfying their expectation and curiosity.

### BACKGROUND OF THE INVENTION

1. Field of the Invention

The present invention herein relates to a method of making egg-shape cookies with molds, particularly to a mold in the shape of an egg cut into half vertically to make cookies required. Two pieces of the cookies can be adhered forming a space inside to contain little stuffs to attract consumers. Therefore, this method of making egg-shape cookies is convenient and practical.

2. Description of the Prior Art

Ultimate fine life is everybody's dream. It includes food, clothing, housing, transportation, education and entertainment. Among all, fine food shows the most beauty of fine life. Dessert in nowadays does not taste good but also looks fantastic. For instance, a piece of cake with nice appearance will increase one's appetite. Based on this conception, people in dessert industry all try their best to invent methods that can produce better desserts. A conventional method to make egg-shape cookies is using two separate molds. The top one is in the shape of an egg cut into half transversely and the bottom one is in the shape of another half. Two halves of cookies are placed together after they are made in these two separate molds. However, with the conventional method, three flaws are found. Firstly, the mold curvature of the two separate parts are different. That means two different molds are needed and the cost of investment will be higher. Secondly, in case any of the two molds is missing, no egg-shape cookies can be made without each other. The last concern is the small contact area. During making process, if the material spreads unevenly, the small contact area will not allow for effective adherence.

### SUMMARY OF INVENTION

In order to compensate the disadvantages as mentioned above, the primary objective of the invention utilizes only one mold in the shape of an egg that is cut into half vertically to make cookies. Two pieces of cookies are made separately with the mold and then adhered together with fluid for making a whole egg, thereby forming a space for any kind of little toys to be placed in the middle of the egg-shape cookies, so as to attract curiosity from customers.

In order to avoid the possibility of missing either top or bottom molds, the further objective of the invention utilizes one single mold for making a complete cookie required. As a result, the invention is not only to save unnecessary waste, but also to make cookies without worrying about the missing of top or bottom parts.

It is still a further objective to make the appearance of cookies more appealing by carving some pattern inside the molds. After the egg-shape cookies is made with the molds, nice patterns will appear on the cookies. Customers will be attracted by the visual effects and willing to purchase and consume it.

### BRIEF DESCRIPTION OF THE DRAWINGS

FIG. 1 is a flow chart of making 3-D egg-shape cookies in the invention herein.

FIG. 2-1 are schematic views illustrating the steps of spreading dough on the mold of the invention herein.

FIG. 2-2 is a perspective view showing that the dough has already been spread evenly in the mold of the invention herein.

FIG. 3 is an exploded view showing that the baked cookies is taken out from the mold of the invention herein.

FIG. 4 is an exploded view showing that two pieces of half egg-shape cookies undergo the adhering process of the invention herein.

FIG. 5 is a schematic view showing the spreading of fluid for adhering purpose indicated in the invention herein.

FIG. 6 is an exploded view showing another preferred embodiment of the invention herein.

### DETAILED DESCRIPTION OF THE PREFERRED EMBODIMENTS

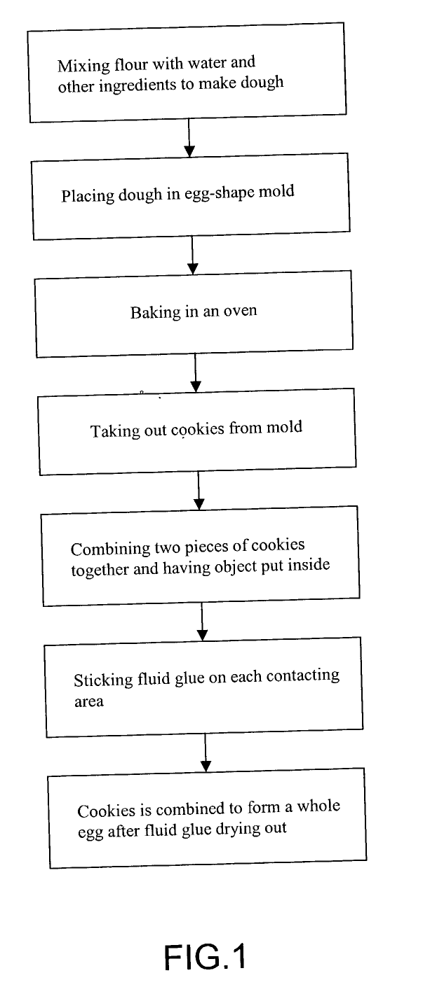

Referring to FIG. 1, is the flow chart of making method of 3-D egg-shape cookies according to the invention herein. The method includes the following steps:

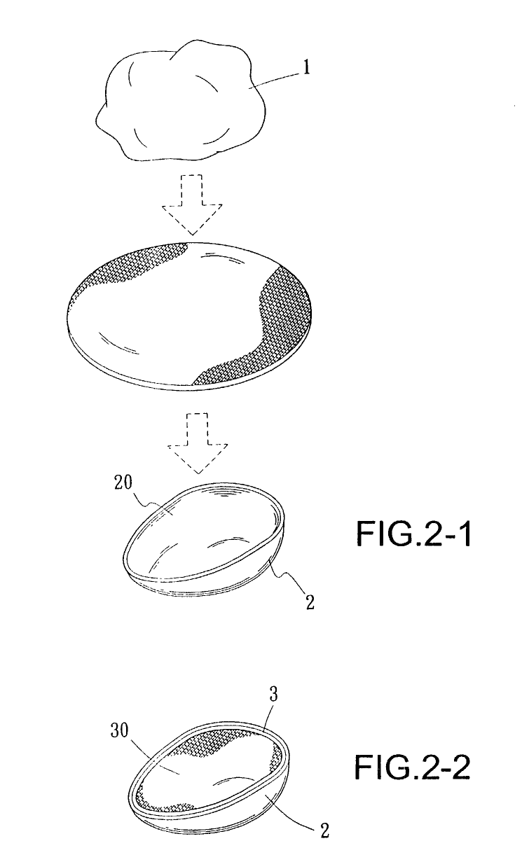

a. Mixing flour with water and other ingredients to make dough 1, and then pressing dough 1 to a piece by spreading on inner curving 20 of a mold 2 in the shape of half-egg. Under this process, cookies 3 will be in the shape of a inner space 30 (see FIG. 2-1 and FIG. 2-2). After placing mold 2 in an oven (not indicated) and heating up thereof, dough 1 will be baked to become cookies 3 in the shape of half-egg.

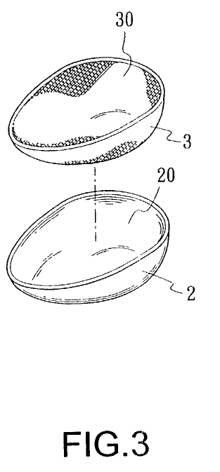

b. Taking out cookies 3 in the shape of half-egg from mold 2 (see FIG. 3, it shows the process of taking out cookies 3 from mold 2 in the shape of half-egg).

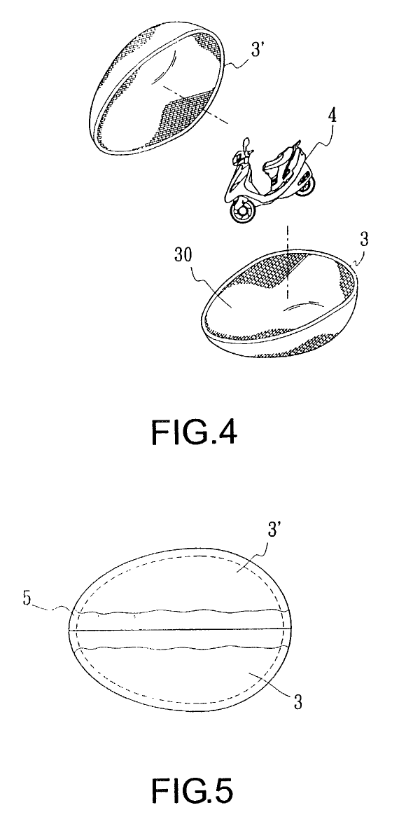

c. Taking two pieces of cookies 3 and cookies 3′ and combine them together (see FIG. 4, it shows how these two pieces of cookies are combined). Object 4 may be put inside the inner space 30 for more fun after space 30 being formed by the combination of cookies 3 and cookies 3′.

d. Sticking cookies 3 and cookies 3′ together with some fluid glue 5 (see FIG. 5, it shows two pieces of cookies in the shape of half-egg glued together with chocolate fluid).

e. After fluid glue 5 drying out, cookies 3 and cookies 3′ will be combined to form a whole egg of the 3-D egg-shape cookies.

According to the descriptions above, the present invention utilizes only one mold 2 in the shape of an egg cut into half vertically as an equipment for making cookies 3 and cookies 3′, which are glued together with fluid glue 5 then. Once the fluid glue 5 dries out, 3-D egg-shape cookies is eventually made thereof. The inner space 30 may contain object 4 for stirring up customers' curiosity and expectation. With one single mold 2 of the invention herein, the cost of investment will decrease; moreover, even any piece of the molds is missing, the final product can still be complete with only one mold.

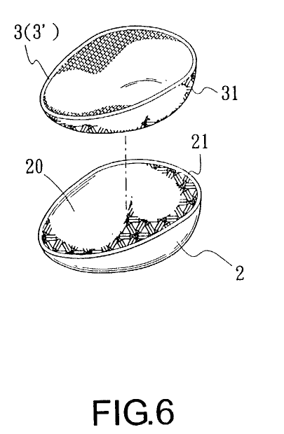

In addition to the description above, the other preferred embodiment is illustrated in FIG. 6. The inner curving 20 of mold 2 can be performed with a plurality of patterns 21, as a result, when dough I is placed in mold 2 and baked, cookies 3 will have pre-arranged patterns 31 on the surface thereof. This process will add some visual flavor on the cookies and stimulate customers' purchasing and tasting desire.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A method of making egg-shape cookies, including following steps:
a. mixing flour with water and other ingredients to make dough for cookies, and then pressing the dough to a piece before spreading on inner curving of a mold in the shape of half-egg; after placing the mold in an oven and heating up in baking process thereof, the dough becoming cookies in the shape of half-egg;.
b. taking and combining together two pieces of cookies in the shape of half-egg;.
c. sticking two pieces of cookies in the shape of half-egg together with fluid glue;
d. 3-D egg-shape cookies is done after the fluid glue drying out; the present invention is based on one mold in the shape of an egg cut into half vertically as an equipment; two pieces of cookies are made with mold and are glued together thereof with the fluid glue forming 3-D egg-shape cookies; cost-saving is achieved by utilizing one single mold of invention herein; moreover, in case any piece of the molds is missing, the final product can still be complete with only one mold.

2. A method of making egg-shape cookies in accordance with claim 1, wherein, in the process of step b, before the two pieces of cookies in half-egg shape are combined, a fun object or tasty stuffing can be put inside the space created by the two pieces cookies in half-egg shape.

3. A method of making egg-shape cookies in accordance with claim 1, wherein, in the process of step c, the fluid glue can be spread over peripheral egg-shape cookies.

4. A method of making egg-shape cookies in accordance with claim 1, the fluid glue can be substituted by sugar water, chocolate, or any other edible fluid turn to be in solidary state after cooling.

5. A method of making egg-shape cookies in accordance with claim 1, the mold in the shape of half-egg is longitudinal that cut into half vertically.

6. A method of making egg-shape cookies in accordance with claim 1, a plurality of patterns made of convex and concave is formed on the mold in the shape of half-egg thereof.
